(19) United States
(12) Patent Application Publication
(10) Pub. No.: US 2014/0298897 A1
(43) Pub. Date: Oct. 9, 2014

(54) HIGH SPEED NANO WEAR TESTING APPARATUS

(71) Applicant: NANOVEA, INC., Irvine, CA (US)

(72) Inventors: Pierre Leroux, Laguna Hills, CA (US); Fernando Valenzuela, Lake Forest, CA (US); Timothy Palermo, Mission Viejo, CA (US); Jeffrey Tomita, Fullerton, CA (US)

(73) Assignee: Nanovea, Inc., Irvine, CA (US)

(21) Appl. No.: 13/859,642

(22) Filed: Apr. 9, 2013

(51) Int. Cl. G01N 3/56

(52) U.S. Cl. CPC G01N 3/56
USPC 73/150 R

(57) ABSTRACT

The present invention is a nano wear testing apparatus, which preferably includes a linear motor, nano module assembly, piezoelectric member, load cell, tip mounting shaft, stage, and speaker coil. The linear motor preferably repositions the nano module assembly in close contact to the surface of a test sample, which is generally attached to the stage. The piezoelectric member moves the load cell and tip mounting shaft near the surface of the sample, and the load cell detects a contact load defined in the software application. The piezoelectric member continues to increase the load until the predetermined load for the test is reached. Once reached, the speaker coils shifts the stage at a frequency and stroke length set in the software application. During the test, the load cell and piezoelectric table continuously adjusts to keep a constant load during the test. Once the test is finished, the speaker coil stops and the load is then removed. Generally, load and depth data is recorded during the test.

### FIELD OF INVENTION

This invention relates generally to nano wear testing apparatuses. In particular, this invention relates to an apparatus for analyzing a test sample for wear testing or tribological testing, at a high speed.

### BACKGROUND

Surface coatings are generally applied onto a surface substrate, primarily to improve the surface properties of that substrate, such as appearance, adhesion, corrosion, wear resistance, and scratch/mar resistance. One type of surface coating method is known as “nano” coating, which is performed by utilizing a controlled surface coating process at the nano level to significantly enhance the ability of the coating to improve its surface properties. Nano coatings may be applied with paint, thermal spray, and/or vacuum technology and are generally performed in a controlled environment.

Generally, when applying nano coatings on a particular surface, manufacturers are concerned as to whether the coating will provide a high resistance level. As a result, many manufacturers have turned to nano scratch testing as an ideal tool to measure scratch/marring resistance on the nano coating surface. This is particularly important for manufacturers because marring damage not only affects visual appearance but can lead to full adhesion failure as environmental conditions access the substrate through the cracked coat. As such, manufacturers tend to test and monitor the level of marring that occurs on a nano coating surface.

One common method of nano testing is scratch testing. Scratch testing is a method or technique where critical loads, at which failures appear, are used to compare the cohesive or adhesive properties of coatings or bulk materials. During scratch testing, a controlled scratch is generated with a sharp tip on a selected area. The scratch may be generated on a sample with a sphero-conical stylus (i.e., tip radius ranging between 1 to 20 μm) which is drawn at a constant speed across the sample, under a constant load, or, more commonly, a progressive load at a fixed loading rate. The tip material may be diamond, which is also typically drawn across the coated surface under a constant, incremental, or progressive load. The scratch test is generally used to characterize and quantify surface parameters such as friction, adhesive strength, and hardness.

To measure the hardness of a surface sample, with a diamond tip, for instance, the surface may be scratched by the diamond tip, and the coating/substrate interface is deformed by relative movement between the sample and diamond point. The load applied to the diamond point may increase continuously as it travels along the surface. Critical points along the scratch may be determined by monitoring the load force (normal to the sample surface) against the frictional force (in the direction of the scratch). A breakdown in the cohesion or adhesion of the film or coating is indicated by a sudden increase in the frictional force. Alternatively or additionally, the machine may have an acoustic emission detector, which monitors the acoustic emission produced during the scratching process. Breakdowns in the coating or film are typically accompanied by sudden increases in the acoustic emissions (sound).

Scratch testing methods, however, are subject to certain limitations. For example, the resistance of a material to abrasion by a single point may be affected by its sensitivity to the strain rate of the deformation process. As a result, the diamond stylus test is conducted under low speeds, which also minimizes the possible effects of frictional heating. The speed of displacement generally continues to be limited to approximately 10 mm/sec, which causes significant problems over the lifetime of the testing, which performs millions of cycles. Test cycles over a lifetime of testing generally lasts more than six months for each device.

Therefore, what is needed is a wear testing apparatus that performs nano wear testing at higher speeds. Preferably, the nano wear testing apparatus performs up to 70 Hertz with a lateral speed of 1400 mm/s, which is generally 140 times faster than conventional scratch testing methods.

### BRIEF SUMMARY OF THE INVENTION

To minimize the limitations in the cited references, and to minimize other limitations that will become apparent upon reading and understanding the present specification, the present invention discloses a new and useful nano wear testing apparatus.

One embodiment of the present invention is a nano wear testing apparatus, comprising: a nano module assembly; a linear motor; a frame; a base; a stage; and a speaker coil; wherein the nano module assembly includes: a piezoelectric member, a tip mounting shaft, and a load cell; wherein the nano module assembly is attached to the linear motor; wherein the linear motor is attached to a top portion of the frame; wherein a bottom portion of the frame is attached to the base; wherein the stage is movably attached to the base, such that the stage is configured to shift along an axis on the base; wherein the stage is configured to secure a test sample; wherein the speaker coil is attached to the base and includes a movable shaft; wherein the movable shaft is attached to the stage; wherein the speaker coil performs the shifting of the stage on the base at a predetermined frequency; wherein the stage is positioned on the base, such that the test sample on the stage is located substantially beneath the nano module assembly; wherein the linear motor repositions the nano module assembly, such that the tip mounting shaft of the nano module assembly is configured to contact a surface of the test sample; wherein the piezoelectric member is configured to move the tip mounting shaft and the load cell near the surface of the test sample to apply a load on the test sample to create an applied load; wherein the load cell measures the applied load on the surface of the test sample to create load data; wherein the load cell detects a predetermined load; wherein the predetermined load is defined in a software application of an electronic data processing unit; wherein the piezoelectric member is configured to increase the applied load until set predetermined load for a test is reached; and wherein the speaker coil shifts the stage along the axis when the load is applied to the test sample. The nano module assembly may further comprises a capacitor ring; wherein the capacitor ring measures a penetration depth to create a depth data when the tip mounting shaft passes through the capacitor ring. The stage may include a plurality of bearings positioned between the stage and the base to reduce a friction as the stage shifts along the base. The base may be comprised of a slab; wherein the slab is attached to the base to increase a stability of the nano wear testing apparatus. The speaker coil may shift the movable shaft to move the movable body at a frequency of at least 70 Hertz. The nano wear testing apparatus may further comprise an acquisition card; wherein the acquisition card is connected to the nano module assembly; wherein the acquisition card collects a plurality of data from the nano module assembly and sends the plurality of data to the electronic data processing unit; wherein the plurality of data includes the load data and the depth data; and wherein the electronic data processing unit processes the plurality of data. The piezoelectric member may move the tip mounting shaft between approximately 0 and 300 microns. The stage may be an X-stage. The stage may be a Y-stage. The load data and the depth data may be recorded by the electronic data processing unit.

Another embodiment of the present invention is a nano wear testing apparatus, comprising: a nano module assembly; a linear motor; a frame; a base; an X-stage; and a speaker coil; wherein the nano module assembly includes: a piezoelectric member, a tip mounting shaft, and a load cell; wherein the nano module assembly is attached to the linear motor; wherein the linear motor is attached to a top portion of the frame; wherein a bottom portion of the frame is attached to the base; wherein the X-stage is movably attached to the base, such that the X-stage is configured to shift along an axis on the base; wherein the X-stage is configured to secure a test sample; wherein the speaker coil is attached to the base and includes a movable shaft; wherein the movable shaft is attached to the X-stage; wherein the speaker coil performs the shifting of the X-stage on the base at a predetermined frequency; wherein the X-stage is positioned on the base, such that the test sample on the X-stage is located substantially beneath the nano module assembly; wherein the linear motor repositions the nano module assembly, such that the tip mounting shaft of the nano module assembly is configured to contact a surface of the test sample; wherein the piezoelectric member is configured to move the tip mounting shaft and the load cell near the surface of the test sample to apply a load on the test sample to create an applied load; wherein the load cell measures the applied load on the surface of the test sample to create load data; wherein the load cell detects a predetermined load; wherein the predetermined load is defined in a software application of an electronic data processing unit; wherein the piezoelectric member is configured to increase the applied load until set predetermined load for a test is reached; wherein the speaker coil shifts the X-stage along the axis; and wherein the load cell and the piezoelectric member continuously adjust the applied load to maintain the predetermined load during the test. The nano module assembly may further comprise a capacitor ring; wherein the capacitor ring measures a penetration depth to create a depth data when the tip mounting shaft passes through the capacitor ring. The stage may include a plurality of bearings positioned between the stage and the base to reduce a friction as the stage shifts along the base. The base may be comprised of a slab; wherein the slab is attached to the base to increase a stability of the nano wear testing apparatus. The speaker coil may shift the movable shaft to move the movable body at a frequency of at least 70 Hertz. The nano wear testing apparatus may further comprise an acquisition card; wherein the acquisition card is connected to the nano module assembly; wherein the acquisition card collects a plurality of data from the nano module assembly and sends the plurality of data to the electronic data processing unit; wherein the plurality of data includes the load data and the depth data; and wherein the electronic data processing unit processes the plurality of data. The piezoelectric member may move the tip mounting shaft between approximately 0 and 300 microns. A height of the linear motor may be adjustable. The load data and the depth data may be recorded by the electronic data processing unit.

Another embodiment of the present invention is a nano wear testing apparatus, comprising: a nano module assembly; a linear motor; a frame; a base; an X-stage; a speaker coil; a slab; and an acquisition card; wherein the nano module assembly includes: a piezoelectric member, a tip mounting shaft, a load cell, and a capacitor ring; wherein the acquisition card is connected to the nano module assembly; wherein the nano module assembly is attached to the linear motor; wherein the linear motor is attached to a top portion of the frame; wherein a height of the linear motor is adjustable; wherein a bottom portion of the frame is attached to the base; wherein the X-stage is movably attached to the base, such that the X-stage is configured to shift along an axis on the base; wherein the stage includes a plurality of bearings positioned between the stage and the base to reduce a friction as the stage shifts along the base; wherein the X-stage is configured to secure a test sample; wherein the speaker coil is attached to the base and includes a movable shaft; wherein the movable shaft is attached to the X-stage; wherein the speaker coil performs the shifting of the X-stage on the base at a predetermined frequency of at least 70 Hertz. wherein the X-stage is positioned on the base, such that the test sample on the X-stage is located substantially beneath the nano module assembly; wherein the linear motor repositions the nano module assembly, such that the tip mounting shaft of the nano module assembly is configured to contact a surface of the test sample; wherein the piezoelectric member is configured to move the tip mounting shaft and the load cell near the surface of the test sample to apply a load on the test sample to create an applied load; wherein the load cell measures the applied load on the surface of the test sample to create load data; wherein the load cell detects a predetermined load; wherein the predetermined load is defined in a software application of an electronic data processing unit; wherein the piezoelectric member is configured to increase the applied load until set predetermined load for a test is reached; wherein the speaker coil shifts the X-stage along the axis; wherein the load cell and the piezoelectric member continuously adjust the applied load to maintain the predetermined load during the test; wherein the capacitor ring measures a penetration depth to create a depth data when the tip mounting shaft passes through the capacitor ring; wherein the slab is attached to the base to increase a stability of the nano wear testing apparatus; wherein the acquisition card collects a plurality of data from the nano module assembly and sends the plurality of data to the electronic data processing unit; wherein the plurality of data includes the load data and the depth data; wherein the electronic data processing unit processes the plurality of data; and wherein the load data and the depth data are recorded by the electronic data processing unit.

Another embodiment is a nano wear testing apparatus, comprising: a nano module assembly; a linear motor; a stage; and a speaker coil; wherein the nano module assembly is comprised of: a piezoelectric member, a tip mounting shaft, and a load cell; wherein the mounting shaft is comprised of a tip; wherein the nano module assembly is attached to the linear motor; wherein the stage is configured to secure a test sample; wherein the speaker coil is comprised of a movable shaft; wherein the movable shaft is attached to the stage; wherein the speaker coil shifts the stage at a predetermined frequency; wherein the stage is positioned such that the test sample on the stage is located substantially beneath the nano module assembly; wherein the linear motor moves the nano module assembly, such that the tip of the tip mounting shaft of the nano module assembly is configured to contact a surface of the test sample; wherein the piezoelectric member is configured to apply a load on the test sample to create an applied load; wherein the load cell measures the applied load on the surface of the test sample to create a load data; wherein the load cell detects a predetermined load; wherein the predetermined load is defined in a software application of an electronic data processing unit; wherein the piezoelectric member is configured to increase the applied load until the predetermined load for a test is reached; and wherein the speaker coil shifts the stage along the axis when the load is applied to the test sample. The nano wear testing apparatus may further comprising: a frame; and a base; wherein the linear motor is attached to a top portion of the frame; wherein a bottom portion of the frame is attached to the base; wherein the stage is movably attached to the base, such that the stage is configured to shift along an axis on the base; and wherein the speaker coil is attached to the base. The nano module assembly may further comprise a capacitor ring; wherein the capacitor ring measures a penetration depth to create a depth data when the tip mounting shaft passes through the capacitor ring. The stage may include a plurality of bearings positioned between the stage and the base to reduce a friction as the stage shifts along the base. The base may be comprised of a slab; wherein the slab is attached to the base to increase a stability of the nano wear testing apparatus. The speaker coil may shift the movable shaft to move the stage at a frequency of at least 70 Hertz. The nano wear testing apparatus may further comprise an acquisition card; wherein the acquisition card is connected to the nano module assembly; wherein the acquisition card collects a plurality of data from the nano module assembly and sends the plurality of data to the electronic data processing unit; wherein the plurality of data includes the load data and the depth data; and wherein the electronic data processing unit processes the plurality of data. The piezoelectric member may moves the tip mounting shaft between approximately 0 and 300 microns. The stage may be an X-stage. The stage may be a Y-stage. The load data and the depth data may be recorded by the electronic data processing unit.

Another embodiment of the present invention is a nano wear testing apparatus, comprising: a nano module assembly; a linear motor; a frame; a base; an X-stage; and a speaker coil; wherein the nano module assembly includes: a piezoelectric member, a tip mounting shaft, and a load cell; wherein the mounting shaft is comprised of a tip; wherein the nano module assembly is attached to the linear motor; wherein the linear motor is attached to a top portion of the frame; wherein a bottom portion of the frame is attached to the base; wherein the X-stage is movably attached to the base, such that the X-stage is configured to shift along an axis on the base; wherein the X-stage is configured to secure a test sample; wherein the speaker coil is attached to the base and includes a movable shaft; wherein the movable shaft is attached to the X-stage; wherein the speaker coil performs the shifting of the X-stage on the base at a predetermined frequency; wherein the X-stage is positioned on the base, such that the test sample on the X-stage is located substantially beneath the nano module assembly; wherein the linear motor repositions the nano module assembly, such that the tip of the tip mounting shaft of the nano module assembly is configured to contact a surface of the test sample; wherein the piezoelectric member is configured to move the tip mounting shaft and the load cell near the surface of the test sample to apply a load on the test sample to create an applied load; wherein the load cell measures the applied load on the surface of the test sample to create load data; wherein the load cell detects a predetermined load; wherein the predetermined load is defined in a software application of an electronic data processing unit; wherein the piezoelectric member is configured to increase the applied load until set predetermined load for a test is reached; wherein the speaker coil shifts the X-stage along the axis; and wherein the load cell and the piezoelectric member continuously adjust the applied load to maintain the predetermined load during the test. The nano module assembly may further comprise a capacitor ring; wherein the capacitor ring measures a penetration depth to create a depth data when the tip mounting shaft passes through the capacitor ring. The stage may include a plurality of bearings positioned between the stage and the base to reduce a friction as the stage shifts along the base. The base may be comprised of a slab; wherein the slab is attached to the base to increase a stability of the nano wear testing apparatus. The speaker coil may shift the movable shaft to move the X-stage at a frequency of at least 70 Hertz. The nano wear testing apparatus may further comprise an acquisition card; wherein the acquisition card is connected to the nano module assembly; wherein the acquisition card collects a plurality of data from the nano module assembly and sends the plurality of data to the electronic data processing unit; wherein the plurality of data includes the load data and the depth data; and wherein the electronic data processing unit processes the plurality of data. The piezoelectric member moves the tip mounting shaft between approximately 0 and 300 microns. A height of the linear motor is adjustable; and wherein the load data and the depth data are recorded by the electronic data processing unit.

Another embodiment of the present invention is a nano wear testing apparatus, comprising: a nano module assembly; a linear motor; a frame; a base; an X-stage; a speaker coil; a slab; and an acquisition card; wherein the nano module assembly includes: a piezoelectric member, a tip mounting shaft, a load cell, and a capacitor ring; wherein the mounting shaft is comprised of a tip; wherein the acquisition card is connected to the nano module assembly; wherein the nano module assembly is attached to the linear motor; wherein the linear motor is attached to a top portion of the frame; wherein a height of the linear motor is adjustable; wherein a bottom portion of the frame is attached to the base; wherein the X-stage is movably attached to the base, such that the X-stage is configured to shift along an axis on the base; wherein the stage includes a plurality of bearings positioned between the stage and the base to reduce a friction as the stage shifts along the base; wherein the X-stage is configured to secure a test sample; wherein the speaker coil is attached to the base and includes a movable shaft; wherein the movable shaft is attached to the X-stage; wherein the speaker coil performs the shifting of the X-stage on the base at a predetermined frequency of at least 70 Hertz; wherein the X-stage is positioned on the base, such that the test sample on the X-stage is located substantially beneath the nano module assembly; wherein the linear motor repositions the nano module assembly, such that the tip of the tip mounting shaft of the nano module assembly is configured to contact a surface of the test sample; wherein the piezoelectric member is configured to move the tip mounting shaft and the load cell near the surface of the test sample to apply a load on the test sample to create an applied load; wherein the load cell measures the applied load on the surface of the test sample to create load data; wherein the load cell detects a predetermined load; wherein the predetermined load is defined in a software application of an electronic data processing unit; wherein the piezoelectric member is configured to increase the applied load until set predetermined load for a test is reached; wherein the speaker coil shifts the X-stage along the axis; wherein the load cell and the piezoelectric member continuously adjust the applied load to maintain the predetermined load during the test; wherein the capacitor ring measures a penetration depth to create a depth data when the tip mounting shaft passes through the capacitor ring; wherein the slab is attached to the base to increase a stability of the nano wear testing apparatus; wherein the acquisition card collects a plurality of data from the nano module assembly and sends the plurality of data to the electronic data processing unit; wherein the plurality of data includes the load data and the depth data; wherein the electronic data processing unit processes the plurality of data; and wherein the load data and the depth data are recorded by the electronic data processing unit.

It is an object of the present invention to provide fast coil technology with a nano level force module for stable wear measurements at low force and fast speed. Specifically, a nano wear testing system preferably performs up to 70 Hertz with a lateral speed of 1400 mm/s, which is generally 140 times faster than conventional scratch testing instruments.

It is an object of the present invention to provide a nano wear testing system that provides an accelerated cycle speed up to 70 Hz and stroke of up to 10 mm with total speed of 1400 mm/s. Preferably, the nano wear testing system enable users of the technology to accelerate development and product certification when long life-cycle test are required for product having low contact force below 2N.

It is an object of the present invention to provide a nano module assembly that utilizes a load cell in closed loop with the piezoelectric member to continuously adjust to keep the applied load consistently applied.

It is an object of the present invention to provide a capacitor ring that measures the depth during a nano wear test. Preferably, the sample is fix on the table bottom moving table and a coil motor is used to provide the smooth displacement at frequencies over 70 Hz.

It is an object of the present invention to provide a nano wear testing apparatus that provides nano indentation testing and any compression test vertically. Additionally, it is preferable that the nano wear testing apparatus provides a fatigue test by applying a dynamic vertical oscillation. Furthermore, it is an object of the present invention to provide a nano wear testing apparatus that could be used to create a scratch with increasing force, such that friction may be measured to add friction data during the test.

It is object of the present invention to provide low load polymer wear applications that accelerates life time test by performing faster frequencies with long strokes.

It is an object of the present invention to overcome the limitations of the prior art.

Other features and advantages are inherent in the sound clip claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of the nano wear testing apparatus and shows a perspective view of the nano wear testing apparatus.

FIG. 2 is an illustration of one embodiment of the nano wear testing apparatus and shows a front view of the nano wear testing apparatus.

FIG. 3 is an illustration of one embodiment of the nano wear testing apparatus and shows a left-side view of the nano wear testing apparatus.

FIG. 4 is an illustration of one embodiment of the nano wear testing apparatus and shows a right-side view of the nano wear testing apparatus.

FIG. 5 is an illustration of one embodiment of the nano wear testing apparatus and shows a rear view of the nano wear testing apparatus.

FIG. 6 is an illustration of one embodiment of the nano wear testing apparatus and shows a top view of the nano wear testing apparatus.

FIG. 7 is an illustration of one embodiment of the nano wear testing apparatus and shows the moveable shaft of the speaker coil shifting the stage along an axis.

FIG. 8 is a side view illustration of one embodiment of the nano wear testing apparatus and shows the linear motor repositioning the nano module assembly.

FIG. 9 is a front view illustration of one embodiment of the nano wear testing apparatus and shows the linear motor repositioning the nano module assembly.

FIG. 10 is a functional block diagram of one embodiment of the nano wear testing apparatus, an acquisition card, and electronic data processing unit and shows the interconnections among the nano wear testing apparatus, acquisition card, and electronic data processing unit.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the term “electronic data processing unit” refers to any device that processes information with an integrated circuit chip, including without limitation, mainframe computers, work stations, servers, desktop computers, portable computers, laptop computers, telephones, smartphones, embedded computers, wireless devices including cellular phones, tablet computers, personal digital assistants, digital media players, portable game players, and hand-held computers.

The present invention preferably provides fast coil technology with a nano level force module for stable wear measurements at low force and fast speed. The present invention preferably performs nano wear testing at a frequency up to 70 Hertz with a lateral speed of 1400 mm/s, which is generally 140 times faster than conventional scratch testing instruments. This is preferably accomplished by providing vertical mounting between the load cell and piezoelectric motor to allow faster reaction than cantilever technologies (e.g., a linear variable differential transformer (LVDT)). The present invention also utilizes a speaker coil to accomplish the smooth and fast technology for the displacement of the sample.

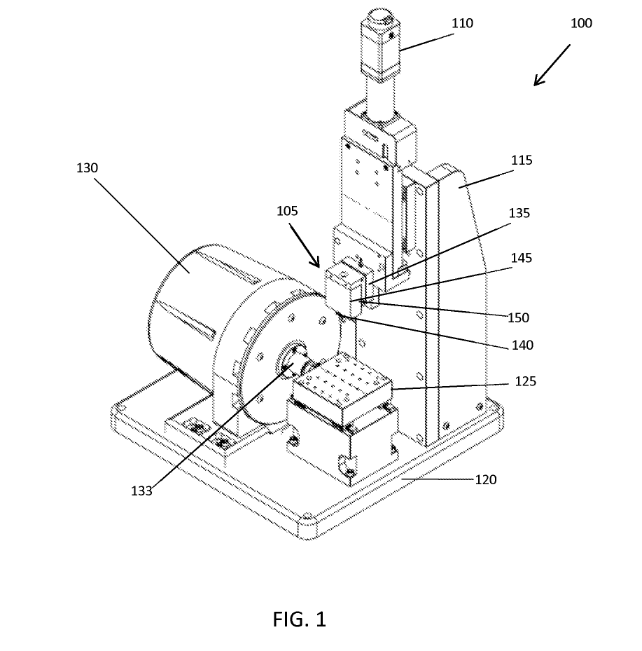

FIG. 1 is an illustration of one embodiment of the nano wear testing apparatus and shows a perspective view of the nano wear testing apparatus. As shown in FIG. 1, the nano wear testing apparatus 100 preferably includes: a nano module assembly 105; linear motor 110; frame 115; base 120; stage 125; speaker coil 130; and moveable shaft 133. The nano module assembly 105 is preferably a portion of the nano wear testing apparatus 100 that creates a quick load control onto the surface of a test sample, which is loaded onto the stage 125 to ensure precise responses to speed. The nano module assembly 105 preferably includes: a piezoelectric member 135; a tip mounting shaft 140; load cell 145; and capacitor ring 150. The piezoelectric member 135 is preferably a piezo actuator or device that provides control of a fast movement of the tip or tip portion of the tip mounting shaft 140 to contact with the surface of a test sample. The tip of the tip mounting shaft is preferably a diamond tip, but may be constructed of other manmade or non-manmade material such as sapphire. The tip may have any desired shape (e.g. conical, hemi-spherical or pyramid-shaped). The piezoelectric member 135 generally functions by the generating electricity or an electric polarity in dielectric crystals when subject to mechanical stress. Alternatively, the piezoelectric member 135 may function by generating mechanical stress in such crystals when subjected to an applied voltage. In one embodiment, the piezoelectric member 135 may be comprised of: (1) a flexure-guided nanopositioning piezo stage 300 μm actuator; (2) an open loop amplifier or controller, and (3) a servo-controlled sub-module, where the servo-control sub-module is preferably a printed circuit board that processes the control signal for the open loop amplifier in order to drive the piezoelectric actuator. The tip mounting shaft 140 is preferably a portion of the nano module assembly 105 that provides contact to the test sample and provides connections to connect various probes. The tip mounting shaft 140 is also preferably connected to the load cell 145. In one embodiment, the tip mounting shaft, in addition to preferably having a tip, may comprise: (1) a preset nano dovetail stage; (2) titanium diamond holder; (3) load cell bracket; and (4) a nano latch. The load cell 145 may preferably be any device that provides precision measuring of a load applied onto the surface of a test sample and may comprise an ultra-low capacity load cell and bracket. The capacitor ring 150 is preferably any sensor device that provides precision measurement of depth data during a test. Specifically, the capacitor ring 150 preferably measures the vertical movement of the tip mounting shaft 140 when the tip mounting shaft 140 passes through the capacitor ring 150.

FIG. 1 also shows that the linear motor 110 is preferably a servo motor with vertical (Z-movement) linear stage that is configured to reposition the nano module assembly 105 to come in contact with the surface of the test sample and is preferably in the range of approximately 50 millimeters. The linear motor 110 may also be adjustable in height. The frame 115 is preferably any structural support (e.g., rear mounting frame or vertical mounting frame) that holds and secures the linear motor 110. The base 120 is preferably the main base plate that provides mounting for the main components of the high speed nano wear testing apparatus, including without limitation, the frame 115, stage 125, and speaker coil 130. The base 120 may also include a slab for further stability by providing additional weight to increase the inertial of the high speed nano wear testing apparatus. The slab is preferably constructed of granite or concrete, but may be constructed from any manmade or non-manmade material. The speaker coil 130 is preferably a device that provides smooth and fast movement of the stage 125 back and forth along an axis (e.g., X-axis, Y-axis, Z-axis) and typically includes a moveable shaft that connects the stage 125. In one embodiment, the speaker coil 130 preferably provides the stage 125 back and forth movement at frequencies exceeding 70 Hertz and for a stroke of up to approximately 10 millimeters. The stage 125 is preferably any device with bearings that is configured to secure a test sample and is generally moveable along an axis on the base 120. The stage 125 may be an X-stage, Y-stage, or Z-stage.

In a preferred embodiment, the linear motor 110 preferably repositions the nano module assembly 105 in very close contact to the surface of a test sample, which is typically attached on the stage 125. The nano module assembly 105 starts moving the load cell 145 and tip mounting shaft 140 until the load cell 145 and tip mounting shaft 140 reach the surface of the test sample, during which the load cell 145 detects a contact load defined in the software application. The piezoelectric member 135 preferably continues to increase the applied load until the set load for the test is reached. Once reached, the speaker coil 130 generally starts moving the stage 125 at a predetermined frequency and stroke length set in the software application. Furthermore, during the test, the load cell 145 and piezoelectric member 135 preferably continuously adjust to maintain a constant load applied during the test. After completion of the test, the speaker coil 130 stops and the applied load is then generally removed. Preferably, load data is generated by the load cell 145, and depth data is generated by the capacitor ring 150. Further, load data and depth data may be recorded during the test. Although FIG. 1 shows the use of a load cell to adjust an applied load, the present invention also allows the use of cantilever technologies to adjust a load such as a linear variable differential transformer (LVDT). Additionally, an LVDT may be used to measure the depth and create depth data. Furthermore, although FIG. 1 shows a capacitor ring installed, the capacitor ring may be removed, without deviating from the scope of the invention.

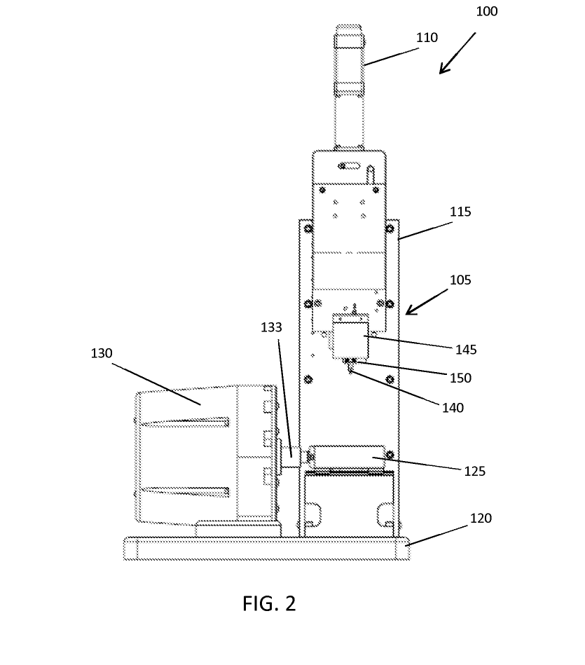

FIG. 2 is an illustration of one embodiment of the nano wear testing apparatus and shows a front view of the nano wear testing apparatus. As shown in FIG. 2, the nano wear testing apparatus 100 preferably includes: a nano module assembly 105; linear motor 110; frame 115; base 120; stage 125; speaker coil 130; and moveable shaft 133. The nano module assembly preferably includes: a tip mounting shaft 140; load cell 145; and capacitor ring 150.

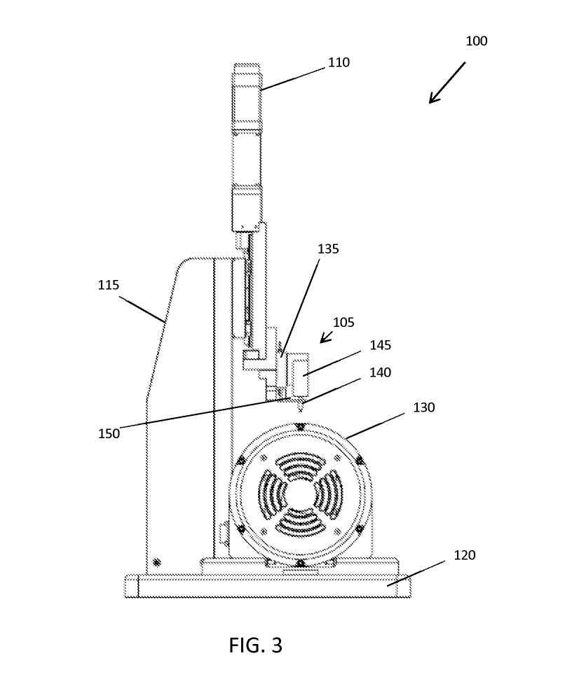

FIG. 3 is an illustration of one embodiment of the nano wear testing apparatus and shows a left-side view of the nano wear testing apparatus. As shown in FIG. 3, the nano wear testing apparatus 100 preferably includes: a nano module assembly 105; linear motor 110; frame 115; base 120; and speaker coil 130. The nano module assembly preferably includes: a piezoelectric member 135; a tip mounting shaft 140; load cell 145; and capacitor ring 150.

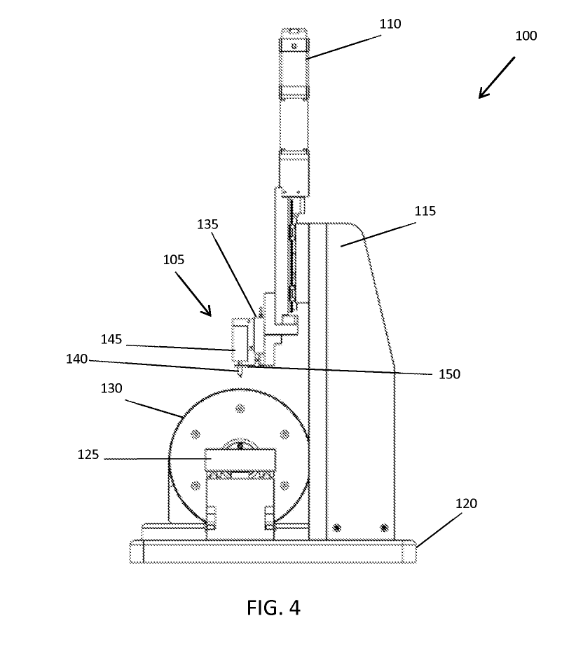

FIG. 4 is an illustration of one embodiment of the nano wear testing apparatus and shows a right-side view of the nano wear testing apparatus. As shown in FIG. 4, the nano wear testing apparatus 100 preferably includes: a nano module assembly 105; linear motor 110; frame 115; base 120; stage 125; and speaker coil 130. The nano module assembly preferably includes: a piezoelectric member 135; a tip mounting shaft 140; load cell 145; and capacitor ring 150.

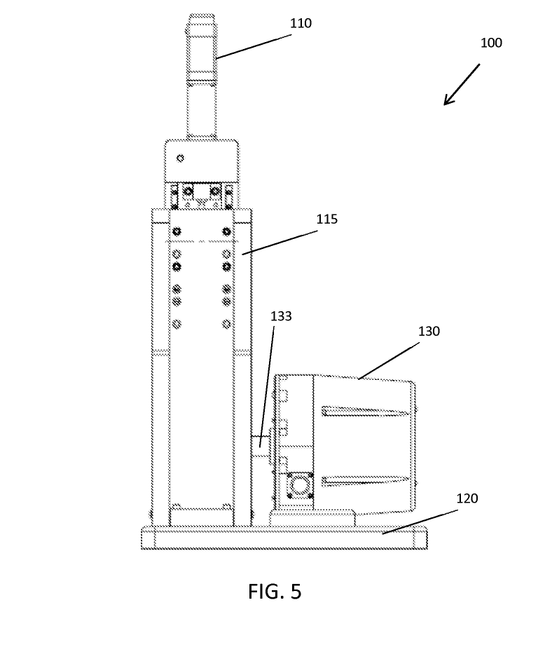

FIG. 5 is an illustration of one embodiment of the nano wear testing apparatus and shows a rear view of the nano wear testing apparatus. As shown in FIG. 5, the nano wear testing apparatus 100 preferably includes: a linear motor 110; frame 115; base 120; speaker coil 130; and moveable shaft 133.

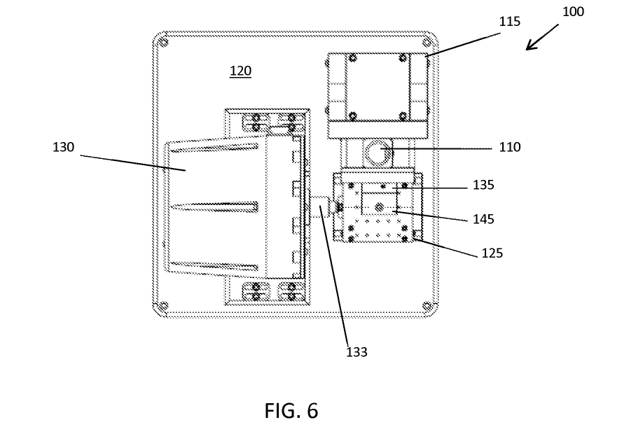

FIG. 6 is an illustration of one embodiment of the nano wear testing apparatus and shows a top view of the nano wear testing apparatus. As shown in FIG. 6, the nano wear testing apparatus 100 preferably includes: a linear motor 110; frame 115; base 120; stage 125; speaker coil 130; piezoelectric member 135; load cell 145; capacitor ring 150; and moveable shaft 133.

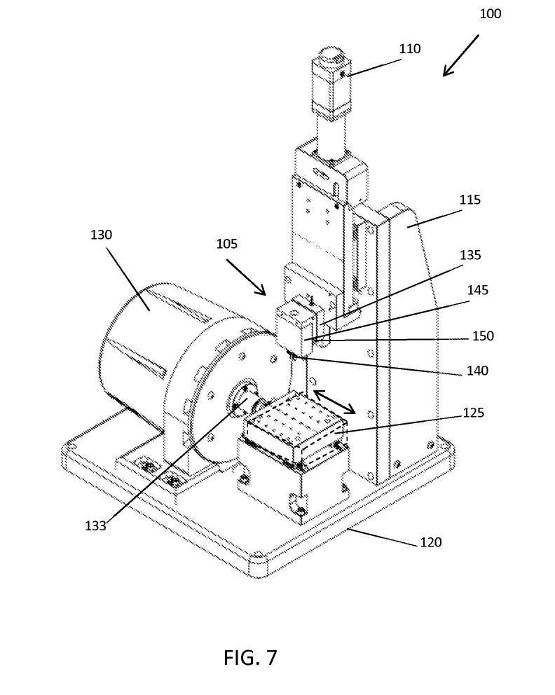

FIG. 7 is an illustration of one embodiment of the nano wear testing apparatus and shows the moveable shaft of the speaker coil shifting the stage along an axis. As shown in FIG. 7, the nano wear testing apparatus 100 preferably includes: a nano module assembly 105; linear motor 110; frame 115; base 120; stage 125; speaker coil 130; and moveable shaft 133. Additionally, the nano module assembly 105 preferably includes: a piezoelectric member 135; a tip mounting shaft 140; load cell 145; and capacitor ring 150. FIG. 7 shows that the moveable shaft 133 of the speaker coil 130 connected to the stage 125 (e.g., X-stage, Y-stage, Z-stage) and generally provides smooth and fast movement of the stage 125 back and forth along an axis (e.g., X-axis, Y-axis, Z-axis). Preferably, the speaker coil 130 provides back and forth movement of the stage 125 at frequencies exceeding 70 Hertz and for a stroke of up to approximately 10 millimeters. However, the present invention also allows the use of speaker coils with strokes exceeding 10 millimeters such as 30 and 50 millimeters. This is generally accomplished by adjusting the length of the moveable shaft 133 or adjusting the back and forward movement by the fluctuations created by the permanent magnet and electromagnetic coil in the speaker coil 130. Further, the present invention allows the use of speaker coil to move the stage 125 at frequencies less than 70 Hertz such as 50 and 40 Hertz. This may be accomplished by employing various drivers (e.g., low frequency drivers) that allows the speaker coil to operate in lower frequencies.

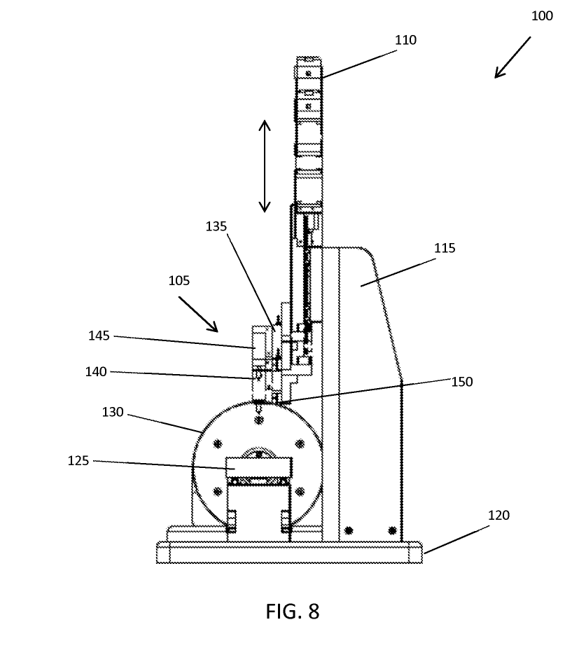

FIG. 8 is a side view illustration of one embodiment of the nano wear testing apparatus and shows the linear motor repositioning the nano module assembly. As shown in FIG. 8, the nano wear testing apparatus 100 preferably includes: a nano module assembly 105; linear motor 110; frame 115; base 120; stage 125; and speaker coil 130. The nano module assembly preferably includes: a piezoelectric member 135; a tip mounting shaft 140; load cell 145; and capacitor ring 150. FIG. 8 shows that the linear motor 110 preferably provides vertical movement (e.g., Z-movement) to reposition the nano module assembly 105 to come in contact with the surface of the test sample. Preferably, the linear motor 110 provides movement in the range of approximately 50 millimeters, but may have a range exceeding 50 millimeters such as 60, 70, and 80 millimeters. As discussed above, this may be accomplished by adjusting the length of the moveable shaft 133 or adjusting the back and forward movement created by the fluctuations created by the permanent magnet and electromagnetic coil in the speaker coil 130.

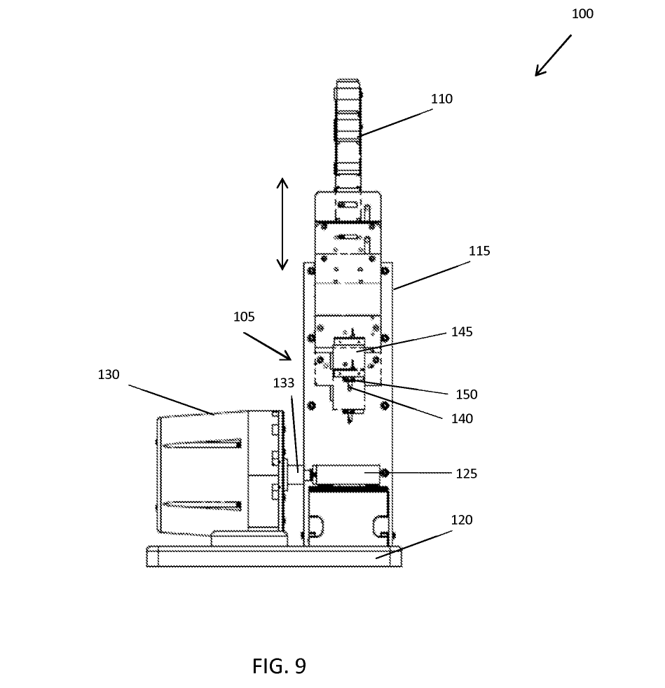

FIG. 9 is a front view illustration of one embodiment of the nano wear testing apparatus and shows the linear motor repositioning the nano module assembly. As shown in FIG. 9, the nano wear testing apparatus 100 preferably includes: a nano module assembly 105; linear motor 110; frame 115; base 120; stage 125; speaker coil 130; and moveable shaft 133. The nano module assembly preferably includes: a tip mounting shaft 140; load cell 145; and capacitor ring 150.

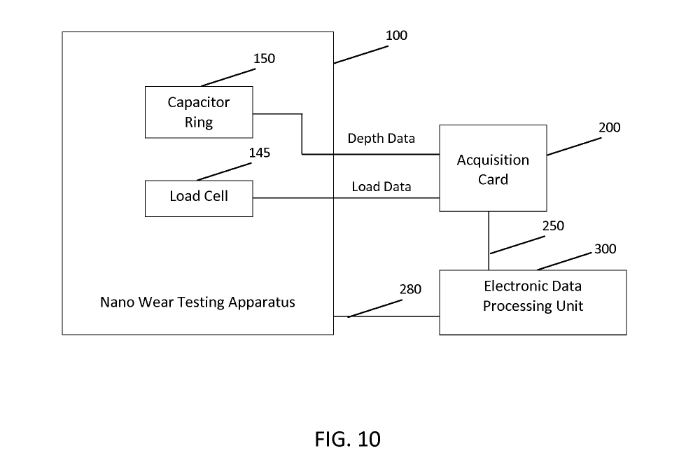

FIG. 10 is a functional block diagram of one embodiment of the nano wear testing apparatus, acquisition card, and electronic data processing unit and shows the interconnections among the nano wear testing apparatus, acquisition card, and electronic data processing unit. As shown in FIG. 9, the nano wear testing apparatus 100 may be connected to an acquisition card 200 and/or electronic data processing unit 300. The acquisition card 200 generally detects data from the nano module assembly 105 such as load data and depth data and preferably communicates such data via a first connection 250 (usually a wired connection) to an electronic data processing unit 300. Based upon the data sent to the electronic data processing unit 300 the electronic data processing unit may provide a feedback control response via second wired connection 280. However, the first wired connection 250 may also be configured to provide control feedback information to the nano wear testing apparatus 100.

Furthermore, all measurement devices may be connected to the electronic data processing unit via data lines and the acquisition card. Although FIG. 9 shows a separate connection via the data acquisition card and data lines to the electronic data processing unit, it should be understood that the lines may be integrated as one unit or may be through a wireless connection.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A nano wear testing apparatus, comprising:
a nano module assembly;
a linear motor;
a stage; and
a speaker coil;
wherein said nano module assembly is comprised of: a piezoelectric member, a tip mounting shaft, and a load cell;
wherein said mounting shaft is comprised of a tip;
wherein said nano module assembly is attached to said linear motor;
wherein said stage is configured to secure a test sample;
wherein said speaker coil is comprised of a movable shaft;
wherein said movable shaft is attached to said stage;
wherein said speaker coil shifts said stage at a predetermined frequency;
wherein said stage is positioned such that said test sample on said stage is located substantially beneath said nano module assembly;
wherein said linear motor moves said nano module assembly, such that said tip of said tip mounting shaft of said nano module assembly is configured to contact a surface of said test sample;
wherein said piezoelectric member is configured to apply a load on said test sample to create an applied load;
wherein said load cell measures said applied load on said surface of said test sample to create a load data;
wherein said load cell detects a predetermined load;
wherein said predetermined load is defined in a software application of an electronic data processing unit;
wherein said piezoelectric member is configured to increase said applied load until said predetermined load for a test is reached; and
wherein said speaker coil shifts said stage along said axis when said load is applied to said test sample.

2. The nano wear testing apparatus of claim 1, further comprising:
a frame; and
a base;
wherein said linear motor is attached to a top portion of said frame;
wherein a bottom portion of said frame is attached to said base;
wherein said stage is movably attached to said base, such that said stage is configured to shift along an axis on said base; and
wherein said speaker coil is attached to said base.

3. The nano wear testing apparatus of claim 2, wherein said nano module assembly further comprises a capacitor ring;
wherein said capacitor ring measures a penetration depth to create a depth data when said tip mounting shaft passes through said capacitor ring.

4. The nano wear testing apparatus of claim 2, wherein said stage includes a plurality of bearings positioned between said stage and said base to reduce a friction as said stage shifts along said base.

5. The nano wear testing apparatus of claim 2, wherein said base is comprised of a slab;
wherein said slab is attached to said base to increase a stability of said nano wear testing apparatus.

6. The nano wear testing apparatus of claim 2, wherein said speaker coil shifts said movable shaft to move said stage at a frequency of at least 70 Hertz.

7. The nano wear testing apparatus of claim 2, further comprising an acquisition card;
wherein said acquisition card is connected to said nano module assembly;
wherein said acquisition card collects a plurality of data from said nano module assembly and sends said plurality of data to said electronic data processing unit;
wherein said plurality of data includes said load data and said depth data; and
wherein said electronic data processing unit processes said plurality of data.

8. The nano wear testing apparatus of claim 2, wherein said piezoelectric member moves said tip mounting shaft between approximately 0 and 300 microns.

9. The nano wear testing apparatus of claim 2, wherein said stage is an X-stage.

10. The nano wear testing apparatus of claim 2, wherein said stage is a Y-stage.

11. The nano wear testing apparatus of claim 2, wherein said load data and said depth data are recorded by said electronic data processing unit.

12. A nano wear testing apparatus, comprising:
a nano module assembly;
a linear motor;
a frame;
a base;
an X-stage; and
a speaker coil;
wherein said nano module assembly includes: a piezoelectric member, a tip mounting shaft, and a load cell;
wherein said mounting shaft is comprised of a tip;
wherein said nano module assembly is attached to said linear motor;
wherein said linear motor is attached to a top portion of said frame;
wherein a bottom portion of said frame is attached to said base;
wherein said X-stage is movably attached to said base, such that said X-stage is configured to shift along an axis on said base;
wherein said X-stage is configured to secure a test sample;
wherein said speaker coil is attached to said base and includes a movable shaft;
wherein said movable shaft is attached to said X-stage;
wherein said speaker coil performs said shifting of said X-stage on said base at a predetermined frequency;
wherein said X-stage is positioned on said base, such that said test sample on said X-stage is located substantially beneath said nano module assembly;
wherein said linear motor repositions said nano module assembly, such that said tip of said tip mounting shaft of said nano module assembly is configured to contact a surface of said test sample;
wherein said piezoelectric member is configured to move said tip mounting shaft and said load cell near said surface of said test sample to apply a load on said test sample to create an applied load;
wherein said load cell measures said applied load on said surface of said test sample to create load data;
wherein said load cell detects a predetermined load;
wherein said predetermined load is defined in a software application of an electronic data processing unit;
wherein said piezoelectric member is configured to increase said applied load until set predetermined load for a test is reached;
wherein said speaker coil shifts said X-stage along said axis; and
wherein said load cell and said piezoelectric member continuously adjust said applied load to maintain said predetermined load during said test.

13. The nano wear testing apparatus of claim 12, wherein said nano module assembly further comprises a capacitor ring;
wherein said capacitor ring measures a penetration depth to create a depth data when said tip mounting shaft passes through said capacitor ring.

14. The nano wear testing apparatus of claim 13, wherein said stage includes a plurality of bearings positioned between said stage and said base to reduce a friction as said stage shifts along said base.

15. The nano wear testing apparatus of claim 14, wherein said base is comprised of a slab;
wherein said slab is attached to said base to increase a stability of said nano wear testing apparatus.

16. The nano wear testing apparatus of claim 15, wherein said speaker coil shifts said movable shaft to move said X-stage at a frequency of at least 70 Hertz.

17. The nano wear testing apparatus of claim 16, further comprising an acquisition card;
wherein said acquisition card is connected to said nano module assembly;
wherein said acquisition card collects a plurality of data from said nano module assembly and sends said plurality of data to said electronic data processing unit;
wherein said plurality of data includes said load data and said depth data; and
wherein said electronic data processing unit processes said plurality of data.

18. The nano wear testing apparatus of claim 17, wherein said piezoelectric member moves said tip mounting shaft between approximately 0 and 300 microns.

19. The nano wear testing apparatus of claim 18, wherein a height of said linear motor is adjustable; and
wherein said load data and said depth data are recorded by said electronic data processing unit.

20. A nano wear testing apparatus, comprising:
a nano module assembly;
a linear motor;
a frame;
a base;
an X-stage;
a speaker coil;
a slab; and
an acquisition card;
wherein said nano module assembly includes: a piezoelectric member, a tip mounting shaft, a load cell, and a capacitor ring;
wherein said mounting shaft is comprised of a tip;
wherein said acquisition card is connected to said nano module assembly;
wherein said nano module assembly is attached to said linear motor;
wherein said linear motor is attached to a top portion of said frame;
wherein a height of said linear motor is adjustable;
wherein a bottom portion of said frame is attached to said base;
wherein said X-stage is movably attached to said base, such that said X-stage is configured to shift along an axis on said base;
wherein said stage includes a plurality of bearings positioned between said stage and said base to reduce a friction as said stage shifts along said base;
wherein said X-stage is configured to secure a test sample;
wherein said speaker coil is attached to said base and includes a movable shaft;
wherein said movable shaft is attached to said X-stage;
wherein said speaker coil performs said shifting of said X-stage on said base at a predetermined frequency of at least 70 Hertz.
wherein said X-stage is positioned on said base, such that said test sample on said X-stage is located substantially beneath said nano module assembly;
wherein said linear motor repositions said nano module assembly, such that said tip of said tip mounting shaft of said nano module assembly is configured to contact a surface of said test sample;
wherein said piezoelectric member is configured to move said tip mounting shaft and said load cell near said surface of said test sample to apply a load on said test sample to create an applied load;
wherein said load cell measures said applied load on said surface of said test sample to create load data;
wherein said load cell detects a predetermined load;
wherein said predetermined load is defined in a software application of an electronic data processing unit;
wherein said piezoelectric member is configured to increase said applied load until set predetermined load for a test is reached;
wherein said speaker coil shifts said X-stage along said axis;
wherein said load cell and said piezoelectric member continuously adjust said applied load to maintain said predetermined load during said test;
wherein said capacitor ring measures a penetration depth to create a depth data when said tip mounting shaft passes through said capacitor ring;
wherein said slab is attached to said base to increase a stability of said nano wear testing apparatus;
wherein said acquisition card collects a plurality of data from said nano module assembly and sends said plurality of data to said electronic data processing unit;
wherein said plurality of data includes said load data and said depth data;
wherein said electronic data processing unit processes said plurality of data; and
wherein said load data and said depth data are recorded by said electronic data processing unit.
